(19) United States
(12) Patent Application Publication
(10) Pub. No.: US 2007/0154597 A1
(43) Pub. Date: Jul. 5, 2007

(54) Food product with enhanced flavor and moistness and method of making the same

(76) Inventor: Donaldson Richmond, Taylor, MI (US)

Correspondence Address: NATH & ASSOCIATES, PLLC, 112 South West Street, Alexandria, VA, 22314, US

(21) Appl. No.: 11/649,799

(22) Filed: Jan. 5, 2007

Related U.S. Application Data
(60) Provisional application No. 60/756,449, filed on Jan. 5, 2006.

(51) Int. Cl. A23L 1/31

(52) U.S. Cl. 426/92

(57) ABSTRACT

Disclosed is a method of making a food product that includes mixing a salt and at least one seasoning to form a dry moisture retaining composition. The composition is made of about ninety-percent salt and about ten percent of seasoning. The dry moisture retaining composition is applied to the food product. The food product is then subjected to an increased temperature for a predetermined time period that is typically between thirteen and twenty-five minutes per pound of the food product.

### CROSS-REFERENCE TO PRIOR APPLICATIONS

This application claims the benefit of U.S. Provisional Application 60/756,449 filed on Jan. 5, 2006, the content of which is hereby incorporated by reference in its entirety.

### FIELD OF THE INVENTION

The present invention, hereinafter relates to the application of moist heat cooking for the retention of moisture in a food product that is subjected to high roasting temperatures.

### BACKGROUND

A problem with roasted turkey is its dry, tough, hard and bland quality. Consumer palates tend to prefer moist, tender, tasty, roasted poultry versus dry, tough, hard and bland poultry. It seems that no matter who cooks the turkey, this problem arises. Sometimes the skin cracks open, the skin crusts and the turkey is often difficult to chew. The turkey seems hardest where the skin cracks. One knows that the crusty skin is a signal that the turkey underneath is at it driest, toughest, hardest and blandest. One dreads the thought of sandwiches made with such dry hard leftovers.

This disappointing palatine quality of roasted turkey is the most perplexing problem frustrating consumers who love, cook and eat roasted turkey. What causes the problem? Why is the terrible holiday turkey such a common experience? Is everyone using the same recipe? Does the problem's cause lie within the turkey or with the person who roasted the turkey?

The following is a list of popular contemporary solutions purported to produce moist and flavorful turkeys:

Deep fat frying involves totally submerging poultry (turkey, chicken, etc.) in cooking oil and frying until done. Other than it's method of transferring heat to the food, deep fat frying is essentially dry heat cooking. The major failing of deep fat frying is the fact it does not manifest complete control over the drying characteristics of the roasting process. A well-known venerable cookbook is “Joy of Cooking” by Rombauer and Becker, (first copyrighted in 1931). Rombauer and Becker describe deep fat frying as just another form of dry heat cooking. To quote Rombauer and Becker:
“Oddly enough, deep-fat frying is still another kind of dry-heat cooking. Here the heat is transferred not only by the oil or fat used as a cooking medium, but by the moisture in the food itself, some of the steam from the food juices being forced into the fat and then out into the atmosphere.”

As moisture in the outer layers vaporizes continually, drying proceeds as osmosis causes inner layer moisture's attraction to the dryer outer layer areas. Given this dynamic, while frying, moisture evaporates continuously from the poultry, escaping into the hot oil and ultimately into the atmosphere, thereby triggering drying characteristics. There is no way to induce moisture retention, prevent toughening or hardening or induce flavor into the poultry. Moreover, deep fat frying invariably leaves oil deposits behind in the cells and extra-cellular-fluid (ECF) area of the meat, which poses unwarranted health risks to those who eat deep fat fried poultry.

Brining and marinating focus on flavor and moistness. Brining and marinating are pre-roasting treatments and tend to be more effective with smaller poultry (10-12 pounds); these methods are relatively ineffective with larger poultry. However, brining does not control drying, toughening and hardening. After brining and removal from the brine, then roasting with contemporary recipes, the poultry undergoes the destructive dynamic of the roasting process. Also, brining and marinating add an undue labor component to the cooking process, which tends to discourage food service operators from the use of brining and marinating.

Consumers have eaten roasted poultry throughout life and have yet to experience moist, tender, tasty, roasted poultry in the same serving. In spite of modem recipes, modem tools, and innovative cooking techniques, the problem remains unsolved.

### SUMMARY OF THE INVENTION

A first embodiment of the present invention is its cooking method—the use of moist heat roasting. Heat transfer takes place through moisture. All other embodiments of the present invention are subordinate to the use of moist heat. This embodiment eliminates the erroneously perceived need to baste the poultry. This embodiment of the present invention includes the step of mixing a salt and at least one seasoning to form a moisture retaining composition. The moisture retaining composition is comprised of about ninety-percent salt and about ten percent seasoning. Next, the moisture retaining composition, in dry-form, is applied to the food product. Last, the food product is roasted for a predetermined time period. The predetermined time period can be anywhere from about thirteen to about twenty-five minutes per pound of the food product. The roasting time period depends on the size of the food product being prepared. The notable quality of this inventive method is the elimination of tampering with the food product during the roasting period. The food product is left untouched during the time it is being roasted. One of the central advantages to this is the commercialization of the process in that processing efforts are greatly reduced.

The composition can be applied to the surface, the interior or both the surface and the interior of any food product. In addition, this product works exceptionally well with fowl such as turkey and chicken, but can also be applied to pork, beef, lamb, venison, vegetables, and any other types of food products.

With respect to fowl, the inventive method of making a food product contains the benefit of reducing the steps necessary for cooking. For example, basting barding and other purported moisturizing methods are unnecessary to produce a moist turkey. The inventive method also includes the step of covering the food product with a water-tight cover. This step allows the creation of a humidified cooking atmosphere. In the end, the present inventive method of making a food product produces a food product that contains more moisture than a food product produced without the application of the moisture retaining composition to the food product.

A second embodiment of the present invention arrests and controls the drying phenomena. The present invention exerts complete control over the evaporation dynamic by its use of moist heat in that it supplies the poultry with more moisture during roasting than might evaporate during the required roasting period. The fundamental characteristic of the present invention causing this dynamic is the induction of active roasting moisture retention and post roasting moisture retention into the food product.

A third embodiment arrests and controls the toughening dynamic of the food product. Given that heat transfer to the poultry takes place primarily by moisture, it is possible to prevent toughening by inducing moisture into the poultry's cells and into the ECF area. In this manner, the present invention maintains fluid levels at maximum potential levels in the cells and ECF area, which accrues from the fact that liquids surround the cells throughout the cooking process.

A fourth embodiment arrests and controls the hardening and petrifying dynamics of the food product. Given that hardening and petrifying takes place after moisture has evaporated below a specific level, the induction and retention of moisture into the cells and ECF during cooking prevents the hardening and petrifying phenomena.

A fifth embodiment arrests and controls the flavor loss dynamic, which occurs across the entire spectrum of this problematic Dynamic. In addition, the present invention eliminates flavor loss, effectively augments the poultry with flavor from an external source, and induces active roasting flavor retention and post roasting flavor retention into the poultry. The seasoning of the moisture retaining composition can be any one of thyme, sage, marjoram, rosemary, black pepper or nutmeg. Alternatively, the seasoning can be a combination of any or all of thyme, sage, maroram, rosemary, black pepper and nutmeg.

As will be discussed below, it has been determined experimentally that a food product produced according to the steps of the inventive method will contain greater moisture than an otherwise similar food product prepared without the moisture retaining composition. Generally, a food product prepared with the present inventive method should be roasted for at least fifteen minutes per pound of food product without removing said water-tight cover. Of course, these roasting times vary with respect to the type of food product being prepared and with respect to the size of the food product being prepared.

As discussed above, the inventive method includes the application of a composition, which itself is inventive. The composition includes a moisture retaining component that is ninety-percent of the composition. The other ten percent of the composition is made primarily of a flavor enhancing compound. Typically, the moisture retaining product is a dendritic salt; whereas the first flavor enhancing component is a pepper. Additional flavoring enhancing components can be added to the composition; such components include, but are not limited to thyme, sage, marjoram, rosemary, and nutmeg.

A further embodiment of the present invention includes a meat product that has been subjected to an ambient area such as an oven, roasting pan, or other heated container. The ambient area should have a temperature of at least three hundred and twenty-five degrees Fahrenheit when the meat product is placed therein. However, prior to placing the meat product in the ambient area, the ambient area should have been at a temperature of about four hundred degrees. A moisture retention composition is added to the food product such that it covers at least thirty percent of the surface of the food product. The food product containing the moisture retention composition is placed in a fluid such as water such that at least three-fourth's of the food product is submerged; preferably, however, the entire food product should be submerged in the fluid. The effect of adding the moisture retention composition to the food product is that it hinders moisture from entering the ambient area, thereby keeping the food product's moisture within the food product itself. The moisture retention composition should help the food product retain moisture in at least a three hundred and twenty-five degree Fahrenheit ambient area for about six hours.

Embodiments of the food product include, but are not limited to meat products such as turkey, chicken, pork, venison, and lamb. No matter the type of meat used, the meat product is not basted, barred with fat, or otherwise tampered with during the roasting process.

### BRIEF DESCRIPTION OF THE DRAWINGS

FIG. 1 shows a thermo-dynamic domain and its prime subordinate domain;

FIG. 2 shows dry heat thermo-dynamic domains; and

FIG. 3 shows a schematic of the entire Roasting Dynamic.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Also, as used herein the terms “meat” and “poultry” unless otherwise specified are synonymous.

In pursuit of understanding the problem at its core, the present inventor engaged in research focused on confirming or disproving the need for a commercial solution to the problem. With respect to establishing compelling indisputable truths of the problem's behavioral tendencies and root causes, the present inventor explored the following cadre of research questions:

The first two questions are logical starting points: “Is poultry naturally dry, tough, hard and bland” and “At what point does the problem first appear?” Poultry is not naturally dry, tough, hard and bland. Nor should it should be after roasting. All poultry, in its raw state, and after being properly roasted, is naturally moist, tender and distinctly tasty. The problem appears after roasting. Something happens between the poultry's preparation for roasting and the end of the roasting period to induce drying, toughening, hardening and flavor loss. This observed fact establishes the fact that the problem's cause is in the roasting technology.

Question 3, the logical nexus: What is the common roasting technology of today? The most common method of roasting poultry is dry heat roasting. Roasting methods define the type of heat employed (dry heat, moist heat) and the manner in which heat transfer to the poultry takes place, convection, conduction, direct. Contemporary roasting methods rarely vary. Almost all contemporary roasting methods employ dry heat with few exceptions.

Question 4, the next logical nexus: “Does the problem occur irrespective of who roasts the turkey and the recipe employed? Is the problem universal?” The finger of blame usually points at the person who roasts the turkey. Given that this person is closely associated with the finished product, to the average consumer, the theory has a degree of credibility. People who cook sometimes make mistakes. On the other hand, without knowledge of the problem's cause, no one can be sure that this person caused the problem.

The operative research question in number 4 is “Does the problem occur irrespective of who roasts the turkey and the recipe employed?” Irrespective of the recipe, when used exactly as prescribed, all contemporary recipes yielded roasted poultry exhibiting one or more of the undesirable palatine qualities with each use. Given this fact, the reasonable conclusion is that the fault is not that of the person who roasts the turkey.

Question number 5, the logical nexus: “Is the problem universal?” The fact that the problem occurs irrespective of the person or recipe involved, confirms the problem as universal to contemporary roasting technology. We know too, that problem's cause activates during roasting. These facts strengthen the conclusion that the problem's source is common to contemporary poultry-roasting recipes.

At this point, we know that the problem is universal to contemporary roasting techniques and occurs irrespective of the person who roasts the turkey, and that the problem happens during the roasting period. All findings point to roasting as the problem. Roasting is the logical nexus. Given these findings, the next two questions (6-7) narrow the focus to an examination of roasting and its dynamics.

Question 6, the logical nexus: “6. Do roasting methods, tools and techniques cause the problem?” The present inventor finds that roasting methods, tools and techniques (roasting technology) do indeed cause the problem. Dynamic phenomena of dry-heat roasting initiate and sustain the problem during roasting. No definition of roasting is complete without a discussion of thermal dynamics. To appreciate the dynamics of roasting requires knowledge of dry heat thermal dynamics. Roasting requires dry heat. Thermal dynamics embody the functional power of heat that drives the problematic process. Roasting requires heat transfer from the heat source to the desired object. Heat's thermal dynamics has the ability to change the mass of all matter in the universe, without exception.

In convection ovens, what begins as convection heating turns to conduction heating as the roasting pan and the air around the poultry saturate with thermal energy and maintain constant contact with the poultry. The atmosphere and roasting pan give up heat to the poultry's mass and the heat source replenishes lost heat in the atmosphere.

Question 7, the logical nexus: What is the basic definition of roasting? Wikipedia, The free (online) encyclopedia, describes roasting in the following manner:
“Roasting is a cooking method that utilizes dry heat, whether an open flame, oven, or other heat source. Traditionally, recognized roasting methods consist only of baking and cooking over or near an open fire. Grilling is normally not technically a roast, since grilled meat is usually seasoned with wet ingredients or marinated. Smoking is not roasting because of the lower heat and controlled smoke application.”

With respect to grilling fowl, this patent document uses the non-traditional usage of the term grilling, i.e., grilling that is “normally” a roast. Objectives and goals of roasting are clear, specific, definite and measurable. Whereas, the online encyclopedia “Wikipedia” uses a general definition of roasting, Merriam-Webster use a more specific and technical definition. Merriam-Webster defines to roast as: “. . . to cook (something) with little or no moisture, as in an oven, over an open fire, or in hot embers . . . to dry, parch, or brown”(New World Dictionary).

Roasting has at least two distinct applications, foods and non-foods. Dynamic phenomena of dry heat roasting are suitable for purposes of non-food light and heavy industry. Non-food industries use dry heat roasting for its dynamic phenomena to alter molecular structure of a product mass. The efficiency of dry-heat in drying and hardening the mass of matter meets commercial production standards of many industrial operations for use in drying hardening, purifying and solidifying industrial products and materials such as lumber, brick, metal, glass, pottery, etc. The definition of roasting leads directly to question eight.

Question 8, the logical nexus: “What specific factors cause the problem?” Outlined below, research findings and conclusions identify the specific factors causing the problem followed by supporting empirical data. The empirical data addresses the definition of roasting and a detailed examination of these problematic factors, which serve as a glossary of the problem's factorial terms.

Thermal dynamics of dry heat has this same predictable impact on meats and poultry: drying, hardening and petrifying. The key dynamics of dry heat roasting are denoted by the active verbs: dry, parch, brown, toast, shrivel, petrify, and terms in the definition of roasting, convert into stone; stony hardness; to make rigid and inert; etc., represent dynamic phenomena that operate on meats and fowl during roasting. This collection of factors and these dynamic phenomena, indigenous to dry heat roasting, are at the core of the problem that causes drying toughening hardening and flavor loss during roasting. Dry heat roasting is efficient at drying parching toughening hardening and purifying (flavor loss in foods).

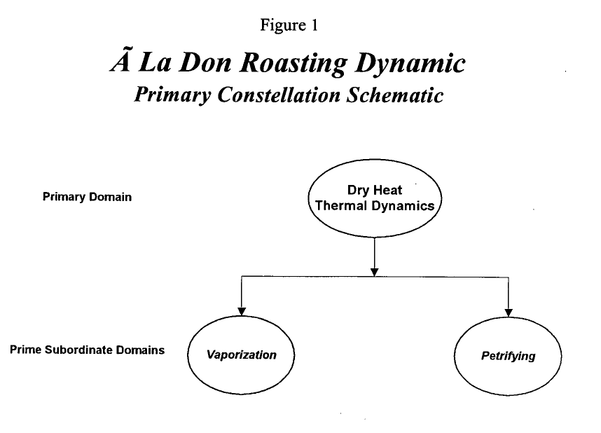

We now know the factors involved in the problem, which leads to question number nine. Question number 9 the logical nexus: 9. “How do those specific factors cause the problems during roasting?” The root of the problem resides in these natural dynamic phenomena indigenous to dry heat roasting. A constellation of three dynamic phenomena, driven by dry-heat thermal dynamics, activate during roasting. Within this three-part constellation, dry-heat thermal dynamics is the primary phenomena, termed a domain, fueling the problem of drying, toughening, hardening and flavor loss. Thermal dynamics initiate, fuel and govern two prime subordinate domains that together form a three-domain constellation of dynamic phenomena. Thermal dynamics, the driving catalyst, is the primary governing domain in this triumvirate. The two prime subordinate domains are vaporization and petrification (see FIG. 1). This collection of dynamic phenomena is termed the A La Don Roasting Dynamic (ALD Roasting Dynamic).

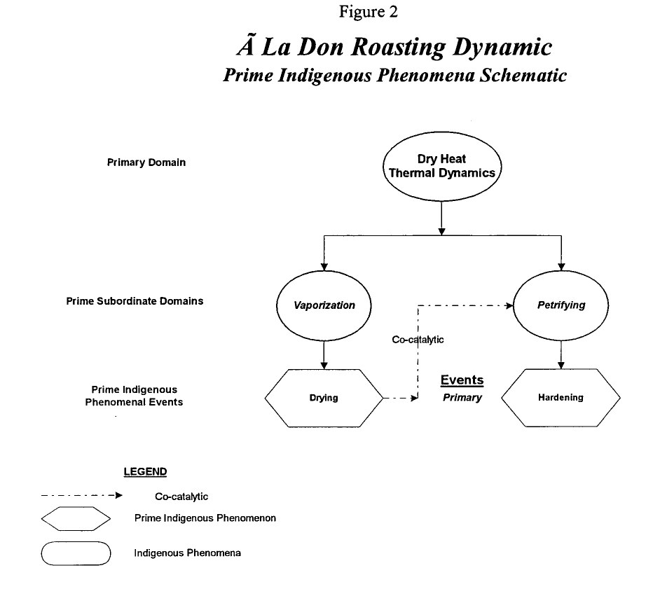

All three domains are active throughout the roasting process. Vaporization and petrification are integrated and mutually interactive. These three component domains form the primary constellation. Vaporization and petrifying consist of a constellation of other subordinate phenomena that operate in a chain of mutually interactive events during roasting. Within each subordinate domain, an indigenous phenomenon exists (prime indigenous phenomenon) and other dynamic phenomena indigenous to its governing domain. Most of the prime and subordinate phenomena operate in a chain of integrated dependant ordinal events. As shown in FIG. 2, some dynamic changes are mutually exclusive, operating solely within their own governing domain and others are operative within multiple domains.

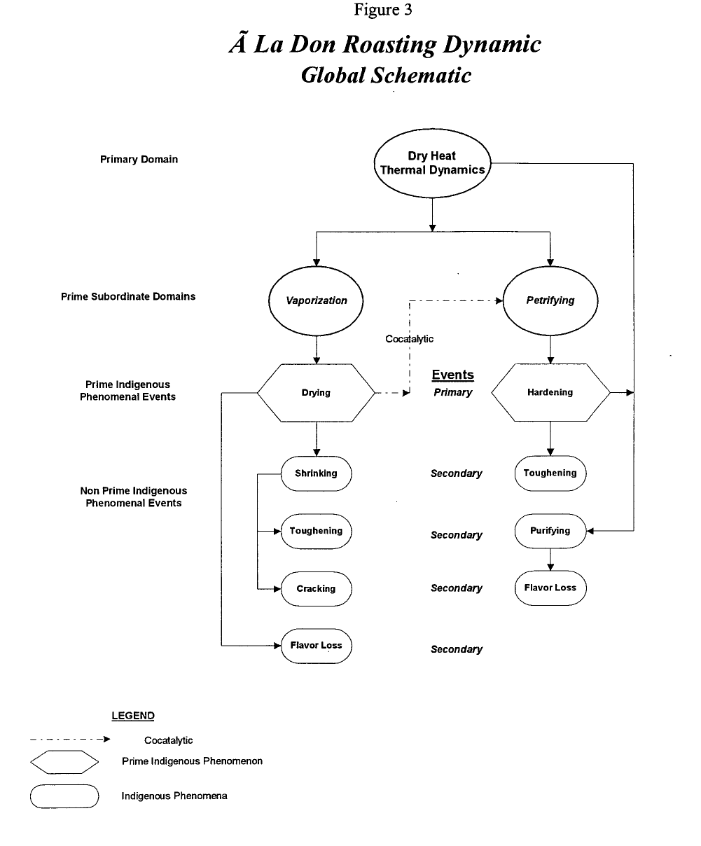

After evaporation progresses to a specific point, the petrifying domain activates. Hardening is the prime indigenous phenomenon of the petrifying domain. Other subordinate dynamics in the petrifying domain are toughening and another form of flavor loss, which is different from the flavor loss of vaporization (explained below). Hardening, toughening and flavor loss occur within both prime subordinate domains of the ALD Roasting Dynamic. FIG. 3 shows a schematic of the entire A La Don Roasting Dynamic.

A brief synopsis on the operative characteristics on all physical dynamics is provided:

Vaporizing: Vaporization is the first phenomena activated by thermal dynamics. Driven by thermal dynamics, roasting heats the moisture trapped inside of the poultry to its vaporization temperature (212° F.; 100° C.) initiating vaporization. The hot vapor (steam), under steam pressure, escapes from the poultry into the atmosphere where it dissipates, which is the evaporation and drying process. Drying, the prime indigenous phenomenon of the vaporization domain activates all other subordinate phenomena within the vaporization domain.

Drying: The drying phenomenon is the governing dynamic in toughening, shrinking, cracking and another form of flavor loss. In addition, drying, as a co-catalyst with thermal dynamics, sets up a dynamic situation that allows petrification to initiate.

Shrinking, Toughening—Drying leads directly to shrinking, toughening and flavor loss. Shrinking and toughening result primarily from the loss of water and fluids. Both are functions of diminished fluids and water volume due to evaporation. Prior to roasting, the poultry has moisture trapped inside of its cells (cellular fluid) and in the area surrounding the cells, termed extra cellular fluid (ECF). These fluids contain water, fats and minerals. These minerals turn hard and bland later in the petrifying phenomena. The poultry's total fluid content visibly influences the visual characteristics, physical volume of its mass, its plumpness, fullness, tenderness and pliability. In addition, the fluid volume in poultry serves to mitigate brittleness, which is a factor in cracking. As moisture evaporates from roasting poultry, the volume of the poultry's mass diminishes and the poultry deflates. This causes the cells to move closer to each other, causing the mass to shrink, tighten and become less pliable from the loss of fluids.

Cracking is rooted in a combination of uneven heating, drying and shrinking as these dynamics progress from the outer layers inward to the deepest layers of the poultry. During roasting, the outer layers of the poultry's mass are exposed to the heat source earlier and longer than inner layers. This causes the outer layers of the poultry to heat, dry and shrink faster than the inner layers. As heating, evaporation, drying and shrinking progress inward, the shrunken outer layers have less surface volume than the cooler inner layers. This causes the outer layers to reach a point where they are drier and more brittle than the less shrunken cooler inner layers. At this point, the more shrunken outer layers can no longer cover the larger volume still manifest in adjacent cooler less shrunken inner layers. This causes breaks at the weakest points of the shrunken brittle outer layers (cracks), usually at points where the meat manifests greater brittleness. Once initiated, this process propagates inward at the point of cracking from the outer layers inward throughout the remaining roasting period. The cracks in the outer surface act as vents for steam escaping from inside of the poultry. These small cracks widen and deepen as the uneven heating, drying and shrinking propagates inward. This permits the venting of increasingly larger amounts of moisture, exacerbating the ALD Roasting Dynamic. Aided and abetted by the power of steam pressure pushing outward from inside, the cracking process feeds on itself cascading inward to the innermost core of the meat, and continues throughout the balance of the roasting period. As the cracks deepen, a labyrinth of cracks, vertical, diagonal and horizontal pathways and tunnels develop within the meat's mass. The labyrinth serves as efficient escape routes venting vaporized moisture, which substantially accelerates and compounds the problem of drying, shrinking and hardening.

Evaporative Flavor Loss occurs throughout the vaporization period as the wet evaporating steam carries out molecules containing materials that our taste buds construe as flavor. The evidence of these escaping flavor components radiate odor, which one smells during roasting. Over extended periods of time, a large amount of flavor components escape during roasting rendering the poultry less tasty than its natural potential. This might seem insignificant until one considers that a 12-15 pound turkey requires about three hours cooking time and poultry ranging 20-25 pounds requires 6 hours or more roasting time.

Hardening results from petrifying. The distinguishing difference between toughening and hardening is that toughening results primarily from loss of fluids and hardening results from mineral deposits hardened by heat after fluid loss. Initiated by petrification, hardening is the prime indigenous phenomenon of the petrifying domain. Hardening does not begin until moisture levels drop to a specific point. Hardening is palpably similar to, but is technically different, from toughening. Whereas toughening results from shrinking and fluid loss, hardening is petrification.

Petrifying occurs as evaporation proceeds and the meat looses its protection of the fluids. Prior to vaporization, the water and fluids in the meat contain taste bearing fats and minerals. Moisture vaporization leaves some of these fats and minerals as deposits in the cells and the ECF area. The deposits are then hardened and purify any remaining flavor in this process.

Purifying flavor loss: In this domain, purifying results in flavor loss. Evaporative flavor loss occurs as long as moisture remains in the meat. Purifying flavor loss and evaporative flavor loss are two distinctly different forms of flavor loss, are mutually exclusive of each other and operate solely within their respective governing domains. The difference is that evaporation carries off taste bearing molecules and petrifying deadens flavor bearing minerals and matter in place within the cells and ECF area. The latter form, as Merriam-Webster defines it, is the process of replacing the normal cells with hardened mineral deposits, thereby re-forming the cells and the ECF area into a stony rigid inflexible inert (tasteless) substance.

Hardening and this form of flavor loss are usually the last dynamics activated in the ALD Roasting Dynamic and they occur simultaneously. Generally, the degree of drying, shrinking, toughening, hardening and bland taste is directly proportional to the temperature and total roasting time. Higher temperatures and longer roasting times relative to total mass tend to yield dryer, tougher, harder roasted poultry and a greater degree of bland taste.

Question 10, the logical nexus: “Do other extraneous factors exacerbate the problem?” Exacerbating the problem is the existence of two different types of meat in fowl such as turkey and chicken, the light breast meat and dark muscle meat. The softer, lighter meat of the breast cooks, dries and toughens faster than the tougher, denser, dark meat of the muscle. Both meats have distinctly different cooking characteristics. Both meats require cooking to their individual state of moist, tender tastiness and proper doneness throughout their mass simultaneously during the same roasting period.

In typical roasting scenarios, after the breast meat reaches its ideal state of moist tender tasty doneness, the dark meat must continue roasting to reach its ideal state of moist tender tasty doneness. This causes the ALD Roasting Dynamic to initiate petrifying earlier in breast meat, and causes it to last longer, than in the dark meat. The dynamics of this dichotomy accounts for the reason that breast meat tends to be much harder and blander than dark meat in fowl such as turkey and chicken cooked with contemporary roasting technology.

Question number 11, the logical nexus: “What have others tried attempting to solve the problem?” The after market sells such things as basting tools, flavor injectors, seasoning rubs, marinades, deep fat fryers, special recipes, roasting pans with V-racks, spices, seasonings, basting brushes and a host of other products purporting to produce roasted poultry meeting consumer desired palatine qualities. Some purported solutions severely intensify the ALD Roasting Dynamic. No purported aftermarket solution exhibits functional mastery of the ALD Roasting Dynamic.

Most aftermarket technology has a focus on just one or two of the consumer-desired qualities. No aftermarket technology focuses on mastering all phenomena of the ALD Roasting Dynamic during roasting. None exhibit knowledge of the ALD Roasting Dynamic and none have an ability to master the ALD Roasting Dynamic. The significance of the longstanding unfulfilled consumer desire underscores the frustration, pent-up demand and negative state of consumer's emotional quotient in the matter.

Basting and Barding poultry are time-honored techniques of traditional roasting recipes in common use worldwide. Faithfully embraced by professionals and non-professionals, basting and barding enjoy enduring respect. In spite of the fact that basting and barding are distinctly different techniques, they have common results in their operative influence on the ALD Roasting Dynamic. Once knowledgeable about the science of each technique, one comes to view their continued use as absurd in pursuit of moist, tender, tasty roasted poultry. One should not use barding or basting for such purposes. These techniques lead to the exact opposite of moist tender tastiness. Basting and Barding are the most vociferous and omnipotent techniques exacerbating the destructive virulence of the ALD Roasting Dynamic than any other roasting technique in common practice.

Question 12, the logical nexus: “Is the poultry industry working on the problem?” The poultry industry consists of many elements, which include poultry breeders, processors, distributors, food service, supermarkets, discount stores and the aftermarket, among other elements.

Other than the aftermarket, the only component of the industry actively working on the problem is poultry processors. However, poultry processors have not taken a scientific approach to solving the problem. Instead, poultry processors appear trapped in the same “time warp” of the aftermarket. Poultry processors have no clue about the ALD Roasting Dynamic.

Most of the top poultry processors imply that they have solved the problem. The top poultry processors emblazon slogans on their turkey wrappers with statements such as the following: i) “contains up to 8% of a solution to enhance juiciness and tenderness;” ii) “turkeys are pre-basted with broth deep inside the food mass, making it more moist and tender;” and iii) “all of our turkeys are self basting, so you don't need to worry about that task.”

Only one of the top turkey processors seems to have some understanding that basting is a frivolous effort. On their website, they note that “there is no need to baste the turkey. (Studies show that liquids do not penetrate in during roasting).” See Norbest, Inc. 2006 at http://www.norbest.com/d_cooking_perfect_turkey.cfm.

Almost all major poultry processors have succumbed to the notion that injecting liquid flavor into their poultry prior to shipment assures moist tenderness after roasting. The common term for this process is the so-called “pre-basting,” which is an absurd notion. Any liquids or flavor bearing minerals trapped inside of the poultry's flesh undergoes the natural dynamics of the ALD Roasting Dynamic, which results in no gain in flavor, moisture, or tenderness. On the other hand, in their ignorance of the ALD Roasting Dynamic, the poultry processors' feeble attempts demonstrate that flavor and liquid injectors are not the solution. More to the point, their belief in a failed solution demonstrates their need for help in this situation.

Question 13, a logical nexus: “Where do Poultry Breeders fit into this equation?” This section addresses poultry breeders because poultry breeders are aware of the problem but believe that modern breeding techniques solve the problem and consistently yield moist tender tasty roasted poultry. In promoting their poultry, breeders commonly use terms like “corn fed,” “free range” “organic fed,” “hormone free.” Many breeders claim that, if their poultry is not overcooked, proper breeding techniques prevents drying, toughening, hardening and flavor loss during roasting. However, what happens on the farm has no influence on dynamic phenomena in the oven

Question 14, a logical nexus: “Where do Poultry Processors fit into this equation?” The qualitative roasting claims of poultry processors are commensurate with contemporary roasting techniques that purport to solve the problem. The websites of poultry processors have recipes that are essentially the same verbiage as recipes on websites of other poultry processors and poultry associations in that all use contemporary roasting technology. All exhibit no knowledge of the fundamental dynamic phenomena comprising the ALD Roasting Dynamic.

Any effective solution must exhibit mastery of the ALD Roasting Dynamic. This requires eliminating, reversing, neutralizing and otherwise controlling all dynamic phenomena of the ALD Roasting Dynamic during roasting such that it yields moist, tender and distinctly tasty roasted poultry. This need formed the basis on which the present inventor formulated and executed product experiments to test and confirm all theories of the ALD Roasting Dynamic.

To solve the problem, a true solution must perform to and exhibit all of the following minimal standards, known as A La Don Roasting Standards, with each use.
Roast dark and white meat to proper doneness without compromising any other quality standard
Prevent drying, cracking, toughening, hardening and flavor loss during roasting
Yield moistness, tenderness and softness in the roasted poultry
Induce distinct tastiness into poultry during roasting
Tenderize poultry during roasting and retain tenderness in leftovers.
Induce post-roasting moisture retention, tenderness and tastiness into poultry during roasting such that leftovers retain these qualities under standard refrigeration for 4-5 days and many months (one year or more) of freezer storage
Minimize excess labor of contemporary roasting technology by eliminating basting, barding, roasting breasts side down, cooking bags, brushing with melted butter, marinating, brining, etc.
Produce these standard qualities in all manner of poultry of any size, which includes but is not limited to wild game, wild and domestic fowl, small, light, lean (i.e., Cornish hens), medium, large and dense poultry
Permit effective use by anyone with zero, minimal, ordinary and advance skill in the art (with or without prior experience with the solution).
Manifest a shelf life in excess of one year
Permit effective use as a rub, marinate and topical application for cut up poultry and meats when frying, grilling, broiling and boiling

Experiments with a wide verity of wild and domestic fowl demonstrated that the present invention's ability to consistently perform to all standards above. Any purported solution that does not fulfill all of the cooking standards simultaneously and concurrently with each use is not effective and fails the consumer. To date, only the present invention fulfills and meets all of the standards above (known as A La Don Roasting Standards).

An embodiment of the composition of the present invention includes ten percent seasoning. The seasoning is made with the following spices: Thyme, Sage, Marjoram, Rosemary, black Pepper and Nutmeg. Ninety percent Dendritic Salt is included in the remainder of the embodiment of the present invention. The ideal roasting pan for Poultry A La Don is a roasting pan that is deep enough to cover the entire bird or bird body part to be roasted.

Methods of preparing turkey using the disclosed composition of the invention include, for every ten pounds of turkey, equally applying 5.5 ounces of the composition of the present invention to a surface of the turkey. For smaller birds, the amount of seasoning should be reduced proportionally, e.g., for a 5 pound turkey, use 3.0 ounces but never less than 3.0 ounces for turkey of any size. Slow even heat an oven preheated to 400-450 degrees. Fill a roasting pan at least ¾ full with water covering all vegetables (including the floor of body cavity); preferably fill the roasting to cover the entire turkey. Sprinkle the present inventive composition on any part of the bird not covered by water and rub into the skin. Ladle remaining inventive composition into the water. Cook covered. Ensure that the top fits snugly without touching the turkey's breast. Do not baste or bard with salt pork (or other fats). Do not open until about 15 minutes before standard cooking time. After placing the food product into the oven, immediately reset the temperature to 325 degrees.

The time required for cooking involves many factors, which include the age of the bird and its fat content, its size and whether it was frozen. However, generally, for birds up to six pounds, allow 20-25 minutes per pound. For poultry larger than six pounds, allow 15-20 minutes per pound. For birds over 16 pounds, allow 13-15 minutes per pound.

After completion of the roasting time, do not assume the bird is fully done; use one or more methods to test for doneness. Three popular tests for doneness are as follows: 1. prick the skin of the thigh to see if the juice runs clear (no blood); 2. jiggle the drumstick to see if the hip joint is loose (the latter response usually means that the bird is fully cooked and very likely overdone, which means some drying may have occurred); and 3. gently squeeze the meaty part of the bird's drumstick between your forefinger and thumb; if the meat gives freely without resistance, the meat is done.

Sometimes with a young bird, the meat close to the bone may remain reddish brown even after adequate cooking. This phenomenon derives from the fact that the bone marrow in immature poultry has not yet fully hardened and the red blood cells sometimes seep into the meat adjacent to the bone.

Do not open the pan or the oven during cooking. This optimizes even distribution at a constant temperature during cooking. Occasionally, one will encounter a bird that requires a little more time than specified in standard cooking times. Accordingly, do not remove the bird from the oven until it doneness is confirmed (as described above). If after checking the bird for doneness, you are not satisfied with its doneness, then cook the bird further using 20-30 minute intervals for testing.

In the end, the present inventive method of making a food product produces a food product that contains more moisture than a food product produced without the application of the moisture retaining composition to the food product. This product works exceptionally well with fowl such as turkey and chicken, but can also be applied to pork, beef, lamb, venison, vegetables, and any other types of food products.

It has been determined experimentally that a food product produced according to the steps of the inventive method will contain greater moisture than an otherwise similar food product prepared without the moisture retaining composition. A roasted food product containing the inventive composition was compared to a food product omitting the inventive composition. The inventive composition was found to cause the food product to withhold more moisture than the food product would have withheld without application of the composition. In the experiment, the moisture retention composition was added to the food product such that it covered at least thirty percent of the surface of the meat product. The food product was subjected to a temperature of over three-hundred degrees for a time period of six hours. The effect of adding the moisture retention composition to the meat product is that it hindered moisture from entering the ambient area, thereby keeping the meat product's moisture within the meat product itself.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein but is to be accorded the widest scope consistent with the principles and novel features disclosed herein.

I claim:

1. A method of making a food product comprising:
mixing a salt and at least one seasoning to form a dry moisture retaining composition, wherein said composition comprises about ninety-percent of said salt and about ten percent of said seasoning;
applying said dry moisture retaining composition to the food product; and
roasting the food product for a predetermined time period, wherein said predetermined time period is between thirteen and twenty-five minutes per pound of the food product.

2. A method of making a food product as recited in claim 1 wherein said at least one seasoning is selected from the group consisting of thyme, sage, marjoram, rosemary, black pepper and nutmeg.

3. A method of making a food product as recited in claim 2 wherein said at least one seasoning consists of a mixture of thyme, sage, marjoram, rosemary, black pepper and nutmeg.

4. A method of making a food product as recited in claim 1 further comprising the step of applying said moisture retaining composition to a fowl product.

5. A method of making a food product as recited in claim 2 further comprising the step of applying said moisture retaining composition to a turkey.

6. A method of making a food product as recited in claim 2 further comprising the step of applying said moisture retaining composition to a chicken.

7. A method of making a food product as recited in claim 2 further comprising roasting the food product while omitting a basting step.

8. A method of making a food product as recited in claim 7 wherein said food product contains greater moisture than an otherwise similar food product prepared without said moisture retaining composition.

9. A method of making a food product as recited in claim 1 further comprising the step of covering said food product with a water-tight cover.

10. A method of making a food product as recited in claim 9 further comprising the step of roasting said food product for at least fifteen minutes per pound of food product without removing said water-tight cover.

11. A method of making a food product as recited in claim 1 wherein the method of making a food product produces a food product containing more moisture than a food product produced without said step of applying said moisture retaining composition.

12. A food product comprising:
a meat product, said meat product having been subjected to an ambient area having a temperature of at least three hundred and twenty-five degrees Fahrenheit; and
a dry moisture retention composition added to said meat product, wherein said moisture retention composition is in communication with at least thirty percent of a surface of said meat product,
wherein said dry moisture retention composition hinders moisture from exiting said meat product.

13. A food product as recited in claim 12 wherein said dry moisture retention composition is configured to prevent said meat product from releasing moisture into said ambient area for a time period of at least six hours.

14. A food product as recited in claim 13 wherein said meat is poultry.

15. A food product as recited in claim 14 wherein said meat is turkey.

16. A food product as recited in claim 12 wherein said meat product is not basted.

17. A dry composition for producing a food product comprising:
a moisture retaining component being ninety-percent of the composition; and
at least one flavor enhancing compound, said flavor enhancing compound being ten percent of the composition.

18. A dry composition for producing a food product as recited in claim 17 wherein said moisture retaining product is a salt.

19. A dry composition for producing a food product as recited in claim 17 wherein said first flavor enhancing component is a pepper.

20. A dry composition for producing a food product as recited in claim 19 further comprising thyme, sage, marjoram, rosemary, and nutmeg.
